(19) United States
(12) Patent Application Publication
(10) Pub. No.: US 2022/0297910 A1
(43) Pub. Date: Sep. 22, 2022

(54) CABLE TIE ASSEMBLY FOR A SYSTEM FOR SECURING AN OBJECT

(71) Applicant: 3M INNOVATIVE PROPERTIES COMPANY, St. Paul, MN (US)

(72) Inventors: Travis P. Betcher, Goodhue, MN (US); Matthew P. Thoms, Red Wing, MN (US)

(21) Appl. No.: 17/753,144

(22) PCT Filed: Aug. 6, 2020
(86) PCT No.: PCT/IB2020/057457

§ 371 Date: Feb. 22, 2022

Related U.S. Application Data
(60) Provisional application No. 62/896,718, filed on Sep. 6, 2019.

(51) Int. Cl. B65D 63/10; F16B 2/08

(52) U.S. Cl. CPC B65D 63/1063; F16B 2/08; F16B 45/04

(57) ABSTRACT

A cable tie assembly includes a frame including an attachment portion adapted to be coupled to a connector and a head portion defining a plurality of apertures therethrough. The head portion includes a plurality of pawls. Each pawl is disposed within a corresponding aperture of the plurality of apertures. The cable tie assembly also includes a plurality of cable ties attached to and extending from the head portion of the frame. The plurality of cable ties are spaced apart from each other and bendable independently of each other. Each cable tie is adapted to be received through a corresponding aperture of the plurality of apertures. Further, each cable tie includes a plurality of teeth on a longitudinal surface thereof. Each tooth of the plurality of teeth is engageable with a corresponding pawl of the plurality of pawls.

### TECHNICAL FIELD

The present disclosure relates to a system for securing an object, and more particularly to a cable tie assembly associated with the system.

### BACKGROUND

An object securing device is typically used to secure an object to a connection point, such as a tool, a machine, or personnel. It is desirable that the device allows easy and secure connection of the object with the connection point. However, some users may incorrectly attach the device to the connection point due to which the object may not be securely held by the to device. Such incorrect attachment of the device with the connection point may be due to availability issues, unfamiliarity of users with the device, or both. It may therefore be desirable to have a device that allows easier and secure connection of objects with the connection point and may be used on a wide range of product types.

### SUMMARY

Generally, the present invention relates to systems used for holding and securing objects of uniform or varying cross-sections.

Some embodiments of the present disclosure relate to a cable tie assembly. The cable tie assembly includes a frame including an attachment portion adapted to be coupled to a connector and a head portion defining a plurality of apertures therethrough. The head portion includes a plurality of pawls. Each pawl is disposed within a corresponding aperture of the plurality of apertures. The cable tie assembly also includes a plurality of cable ties attached to and extending from the head portion of the frame. The plurality of cable ties are spaced apart from each other and bendable independently of each other. Each cable tie is adapted to be received through a corresponding aperture of the plurality of apertures. Further, each cable tie includes a plurality of teeth on a longitudinal surface thereof. Each tooth of the plurality of teeth is engageable with a corresponding pawl of the plurality of pawls.

In some embodiments, the plurality of cable ties are adapted to be secured around an object having a varying cross-section.

In some embodiments, the cable tie assembly further includes a gripping member coupled with the plurality of cable ties.

In some embodiments, the gripping member receives a portion of each of the plurality of cable ties.

In some embodiments, the gripping member is adapted to be disposed around and contact an object that is secured to the cable tie assembly.

In some embodiments, the gripping member includes a base portion, and a plurality of walls extending from the base portion and spaced apart from each other. A plurality of channels is defined by the gripping member. Each channel is disposed between adjacent walls of the plurality of walls. Each channel at least partially receives a corresponding cable tie of the plurality of cable ties.

In some embodiments, each cable tie defines a plurality of holes therethrough. The base portion further includes a plurality of protrusions disposed within each channel. The plurality of protrusions are received within the plurality of holes of the corresponding cable tie.

In some embodiments, the gripping member is made from a flexible material.

In some embodiments, the gripping member is made from a plastic material.

In some embodiments, the gripping member is integral with the frame.

In some embodiments, the cable tie assembly includes at least two cable ties.

In some embodiments, each cable tie is made from a flexible material.

In some embodiments, each cable tie is made from a plastic material.

In some embodiments, the attachment portion defines a connector opening therethrough, the connector opening adapted to be coupled to the connector.

In some embodiments, the attachment portion further includes a curved section attached to the head portion and defining the connector opening. The attachment portion also includes a pair of lateral sections extending outwardly from the curved section and attached to the head portion.

Some embodiments of the present disclosure relate to a system for securing an object. The system includes a cable tie assembly. The cable tie assembly includes a frame including an attachment portion and a head portion defining a plurality of apertures therethrough. The head portion includes a plurality of pawls. Each pawl is disposed within a corresponding aperture of the plurality of apertures. The cable tie assembly also includes a plurality of cable ties attached to and extending from the head portion of the frame. The plurality of cable ties are spaced apart from each other and bendable independently of each other. Each cable tie is adapted to be received through a corresponding aperture of the plurality of apertures. Further, each cable tie includes a plurality of teeth on a longitudinal surface thereof. Each tooth of the plurality of teeth is engageable with a corresponding pawl of the plurality of pawls. The plurality of cable ties are secured around the object. Further, the system includes a connector coupled to the attachment portion of the frame.

In some embodiments, the connector is integral with the attachment portion of the frame.

Some embodiments of the present disclosure relate to a cable tie assembly for holding an object. The cable tie assembly includes a frame including an attachment portion adapted to be coupled to a connector and a head portion defining a plurality of apertures therethrough. The head portion includes a plurality of pawls. Each pawl is disposed within a corresponding aperture of the plurality of apertures. The cable tie assembly also includes a plurality of cable ties attached to and extending from the head portion of the frame. The plurality of cable ties are spaced apart from each other and bendable independently of each other. Each cable tie is adapted to be received through a corresponding aperture of the plurality of apertures. Further, each cable tie includes a plurality of teeth on a longitudinal surface thereof. Each tooth of the plurality of teeth is engageable with a corresponding pawl of the plurality of pawls. The plurality of cable ties are secured around the object. The cable tie assembly further includes a gripping member coupled to the plurality of cable ties. The gripping member receives a portion of each cable tie. The gripping member is adapted to be disposed around and contact the object.

### BRIEF DESCRIPTION OF THE DRAWINGS

Exemplary embodiments disclosed herein may be more completely understood in consideration of the following detailed description in connection with the following figures. The figures are not necessarily drawn to scale. Like numerals used in the figures refer to like components. When pluralities of similar elements are present, a single reference numeral may be assigned to each plurality of similar elements with a small letter designation referring to specific elements. When referring to the elements collectively or to a non-specific one or more of the elements, the small letter designation may be eliminated. However, it will be understood that the use of a numeral to refer to a component in a given figure is not intended to limit the component in another figure labeled with the same number.

FIG. 1 is a perspective view of a system and an object held by the system according to an embodiment of the present disclosure;

FIG. 2 is an exploded view of the system having a cable tie assembly;

FIG. 3 is a bottom view of the cable tie assembly shown in FIG. 2; and

FIG. 4 is a perspective view of the system shown in FIG. 2; and

FIG. 5 is a front view of a cable tie assembly according to an embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

The present disclosure relates to a system having a cable tie assembly and a connector. The system may be used to hold and secure an object with a connection point such as a tool, a machine, or personnel. Further, a head portion of the cable tie assembly provides an anchor point to which the connector can be easily connected and may allow a user to easily secure the system with the connection point. Moreover, the cable tie assembly includes multiple cable ties that allow the cable tie assembly to hold objects of varying cross-section as well as uniform cross-section. In various examples, the system may be used to hold tool handles or objects that have handles with varying cross sections. The system described herein may be used on a wide range of product types.

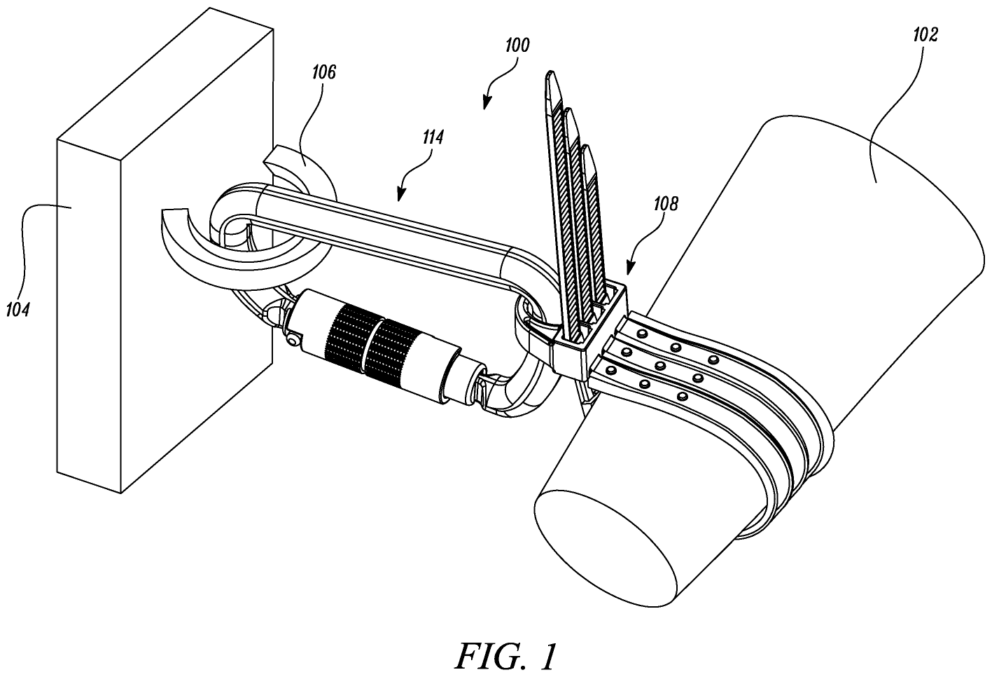

FIG. 1 illustrates an exemplary system 100 for securing an object 102. The system 100 is used to hold the object 102 and secure the object 102 to a connection point 104. In an example, the object 102 may embody a tool or any other object of industrial, commercial, or personal use, without any limitations. Further, the object 102 may have a uniform cross-section or a varying cross-section. In the illustrated example, the object 102 has a varying cross-section. Further, the connection point 104 may include any one of a machine, a tool, and the like. Alternatively, the connection point 104 may include a belt of an operator or service personnel. For example, the system 100 may be used to connect objects to the belt of an operator or service personnel. In the illustrated example, the connection point 104 includes a loop 106. The system 100 may be secured to the loop 106. Alternatively, the connection point 104 may include any other means that allows connection of the system 100 with the connection point 104.

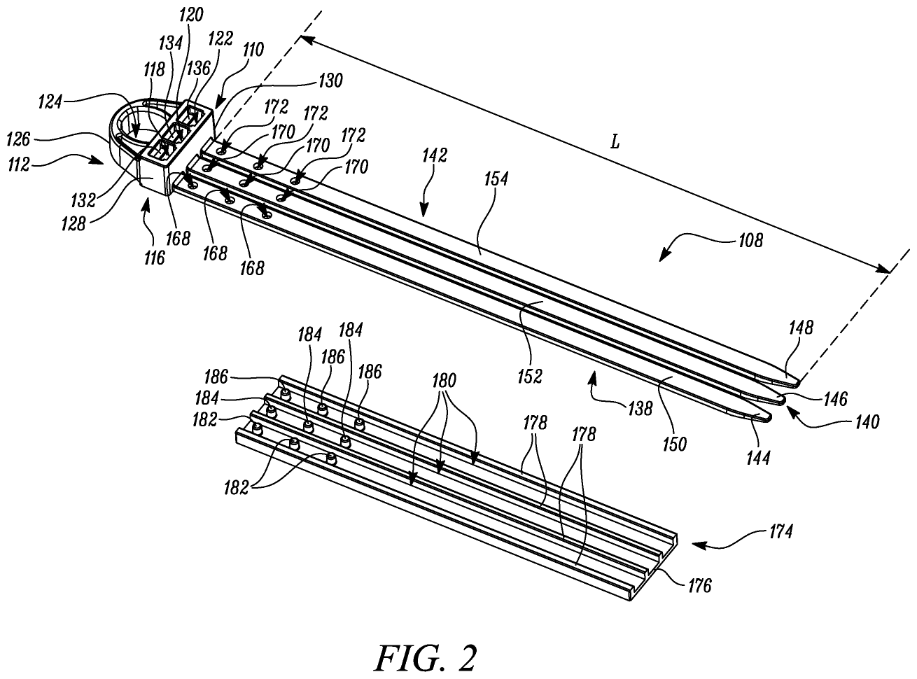

Referring to FIG. 2, the system 100 includes a cable tie assembly 108. The cable tie assembly 108 includes a frame 110. In an example, the frame 110 is embodied as a molded component and may be made from a plastic material. The frame 110 includes an attachment portion 112 adapted to be coupled to a connector 114 (shown in FIGS. 1, 3, and 4) and a head portion 116 defining a plurality of apertures 118, 120, 122 therethrough. Each of the apertures 118, 120, 122 is approximately square shaped. However, a shape of the apertures 118, 120, 122 may vary as per system requirements. The attachment portion 112 defines a connector opening 124 therethrough. The connector opening 124 is circular in shape. However, a shape of the connector opening 124 may vary as per system requirements. The connector opening 124 is adapted to be coupled to the connector 114.

Further, the attachment portion 112 includes a curved section 126 attached to the head portion 116 and defining the connector opening 124. It should be noted that the attachment portion 112 provides an integrated attachment point that allows connection of the cable tie assembly 108 with the connection point 104 via the connector 114. More particularly, the attachment portion 112 allows quick and secure coupling of the cable tie assembly 108 with the connector 114. The attachment portion 112 also includes a pair of lateral sections 128, 130 extending outwardly from the curved section 126 and attached to the head portion 116. In the illustrated example, the head portion 116 includes three apertures 118, 120, 122. However, a number of the apertures 118, 120, 122 in the head portion 116 may vary based on application requirements. The head portion 116 includes a plurality of pawls 132, 134, 136. Each pawl 132, 134, 136 is disposed within a corresponding aperture 118, 120, 122 of the plurality of apertures 118, 120, 122. The pawls 132, 134, 136 provide a retention feature when a plurality of cable ties 138, 140, 142 are engaged with the head portion 116.

The cable tie assembly 108 also includes the plurality of cable ties 138, 140, 142 attached to and extending from the head portion 116 of the frame 110. The cable ties 138, 140, 142 are integrally attached with the head portion 116. The cable ties 138, 140, 142 are equidistantly disposed with respect to each other. The cable ties 138, 140, 142 are embodied as flexible elongate straps. More particularly, each cable tie 138, 140, 142 is made from a flexible material. In an example, each cable tie 138, 140, 142 is made from a plastic material. For example, each of the cable ties 138, 140, 142 may be made of nylon or polypropylene material. Further, the cable ties 138, 140, 142 may be reinforced with fibers to increase their strength. In some examples, the cable ties 138, 140, 142 and the frame 110 are made of the same material. Each of the cable ties 138, 140, 142 is generally rectangular in shape.

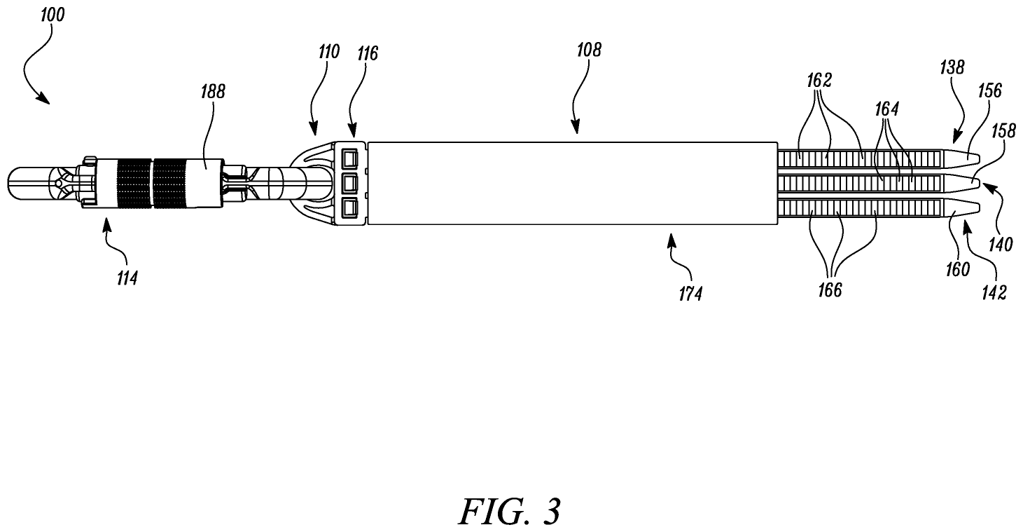

Further, each of the cable ties 138, 140, 142 includes a tail portion 144, 146, 148. Each of the cable ties 138, 140, 142 define a first longitudinal surface 150, 152, 154 and a second longitudinal surface 156, 158, 160 (shown in FIG. 3) that is disposed opposite to the first longitudinal surface 150, 152, 154. The plurality of cable ties 138, 140, 142 are secured around the object 102. More particularly, the plurality of cable ties 138, 140, 142 are adapted to be secured around the object 102 having the varying cross-section. In some examples, the cable ties 138, 140, 142 may be secured to a handle of the object 102. In such examples, the handle of the object 102 may include a varying cross-section or a uniform cross-section. Moreover, the plurality of cable ties 138, 140, 142 are adapted to be secured around the object 102 having a uniform cross-section.

A number of the cable ties 138, 140, 142 correspond to the number of the apertures 118, 120, 122 provided in the head portion 116 of the frame 110. The cable tie assembly 108 includes at least two cable ties. In the illustrated example, the cable tie assembly 108 includes three cable ties 138, 140, 142. However, the number of the cable ties 138, 140, 142 may vary based on application requirements. It should be noted that overall dimensions of the cable tie assembly 108 may vary based on the number of the cable ties 138, 140, 142 associated with the cable tie assembly 108. More particularly, as the number of the cable ties 138, 140, 142 increases, dimensions of the frame 110 may increase to accommodate corresponding number of the cable ties 138, 140, 142. Moreover, dimensions of the apertures 118, 120, 122 may also vary based on dimensions of the cable ties 138, 140, 142 so that the cable ties 138, 140, 142 may be received within the corresponding aperture 118, 120, 122.

The plurality of cable ties 138, 140, 142 are spaced apart from each other and bendable independently of each other. Thus, the cable ties 138, 140, 142 may be independently adjusted with respect to each other so that proper tension can be attained on the object 102, specifically, when the object 102 includes a varying cross-section. Each cable tie 138, 140, 142 is adapted to be received through the corresponding aperture 118, 120, 122 of the plurality of apertures 118, 120, 122. Each cable tie 138, 140, 142 includes a plurality of teeth 162, 164, 166 (shown in FIG. 3) on the second longitudinal surface 156, 158, 160 (shown in FIG. 3) thereof. The teeth 162, 164, 166 are provided in a parallel arrangement on each of the cable ties 138, 140, 142 and are uniformly arranged on the corresponding longitudinal surface 156, 158, 160. Each tooth 162, 164, 166 of the plurality of teeth 162, 164, 166 engageable with a corresponding pawl 132, 134, 136 of the plurality of pawls 132, 134, 136.

Referring now to FIGS. 2 and 3, each of the cable ties 138, 140, 142 defines a loop that receives a portion of the object 102 (see FIG. 1) when the teeth 162, 164, 166 (see FIG. 3) engage with the corresponding pawl 132, 134, 136 (see FIG. 2). For locking the cable tie 138, 140, 142 with the corresponding aperture 118, 120, 122 (see FIG. 2), the tail portion 144, 146, 148 (see FIG. 2) of each of the cable ties 138, 140, 142 is inserted into the corresponding aperture 118, 120, 122 and is pulled. Based on the pull applied on the cable ties 138, 140, 142, the pawls 132, 134, 136 mate with and ratchet over the plurality of teeth 162, 164, 166 on the corresponding cable ties 138, 140, 142. Further, as the cable ties 138, 140, 142 are tightened by pulling, the pawl 132, 134, 136 locks with the teeth 162, 164, 166 on the corresponding cable tie 138, 140, 142 to prevent the cable tie 138, 140, 142 from loosening. More particularly, the pawl 132, 134, 136 is pressed against the corresponding cable tie 138, 140, 142 with a force which is sufficient to prevent it from being withdrawn from the corresponding aperture 118, 120, 122 of the head portion 116.

As shown in FIG. 2, the cable tie 138, 140, 142 defines a plurality of holes 168, 170, 172 therethrough. The holes 168, 170, 172 are disposed proximate to the head portion 116 of the frame 110. In the illustrated example, each cable tie 138, 140, 142 includes three holes 168, 170, 172, such that the cable tie assembly 108 includes nine holes 168, 170, 172 in total. In alternate examples, the cable tie assembly 108 may include more than nine holes 168, 170, 172 based on application requirements.

Further, the cable tie assembly 108 includes a gripping member 174 coupled with the plurality of cable ties 138, 140, 142. The gripping member 174 is generally rectangular in shape. The gripping member 174 is made from a flexible material. In an example, the gripping member 174 is made from a plastic material. For example, the gripping member 174 may be made from a soft, thermoplastic material. The gripping member 174 may be embodied as a molded component. The gripping member 174 receives a portion of each of the plurality of cable ties 138, 140, 142. In some examples, the gripping member 174 extends along more than half of an overall length “L” of each of the cable ties 138, 140, 142. In the illustrated example, the gripping member 174 is manufactured as a separate component and is later assembled with the frame 110. Alternatively, the gripping member 174 is integral with the frame 110. In such an example, the gripping member 174 may be molded with the frame 110 using a two shot molding process.

The gripping member 174 is adapted to be disposed around and contact the object 102 that is secured to the cable tie assembly 108. More particularly, the gripping member 174 is used to improve friction between the object 102 and the cable ties 138, 140, 142 in order to allow better grasping of the object 102 by the cable tie assembly 108. It should be noted that dimensions of the gripping member 174 may vary based on the dimensions of the cable ties 138, 140, 142. The gripping member 174 includes a base portion 176, and a plurality of walls 178 extending from the base portion 176 and spaced apart from each other. Further, a plurality of channels 180 is defined by the gripping member 174. Each channel 180 is disposed between adjacent walls 178 of the plurality of walls 178. Further, each channel 180 at least partially receives the corresponding cable tie 138, 140, 142 of the plurality of cable ties 138, 140, 142.

The base portion 176 further includes a plurality of protrusions 182, 184, 186 disposed within each channel 180. As shown in FIG. 3, the plurality of protrusions 182, 184, 186 are received within the plurality of holes 168, 170, 172 (see FIG. 2) of the corresponding cable tie 138, 140, 142. When the protrusions 182, 184, 186 are received within the corresponding holes 168, 170, 172, the gripping member 174 is secured proximate to the head portion 116 of the frame 110. More particularly, the cable ties 138, 140, 142 are received and secured within the channels 180 when the protrusions 182, 184, 186 are received within the corresponding holes 168, 170, 172. It should be noted that a location of the protrusions 182, 184, 186 and the holes 168, 170, 172 may vary based on a desired securing location of the gripping member 174 with respect to the cable ties 138, 140, 142. In the illustrated example, the base portion 176 includes nine protrusions 182, 184, 186. More particularly, the protrusions 182, 184, 186 are provided such that three protrusions 182, 184, 186 are disposed within each channel 180 (see FIG. 2). In alternate examples, the base portion 176 may include more than nine protrusions 182, 184, 186 based on application requirements.

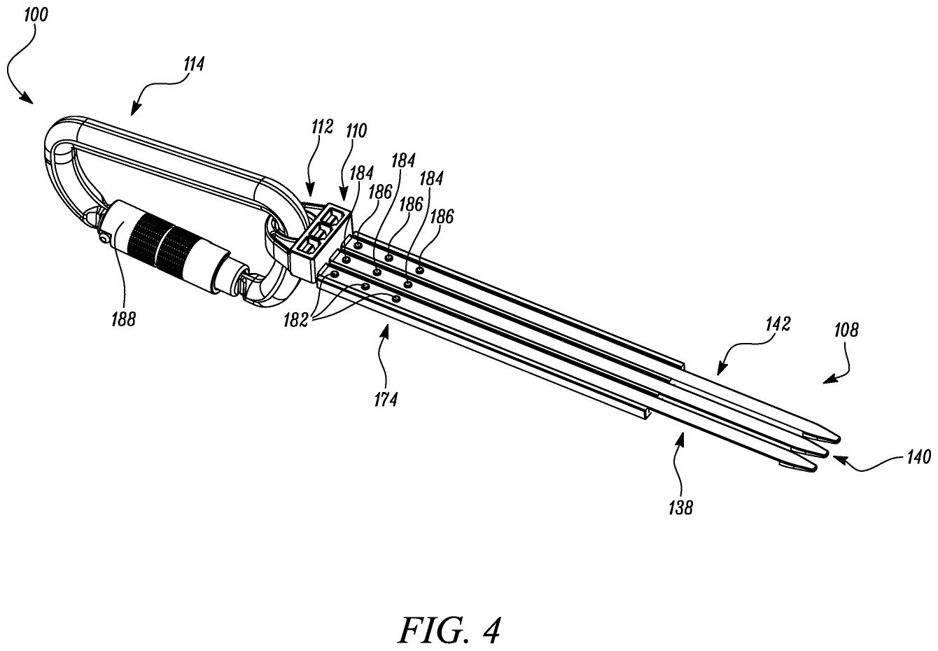

As shown in FIG. 4, the system 100 also includes the connector 114. The connector 114 is coupled to the attachment portion 112 of the frame 110. More particularly, the connector 114 is received within the connector opening 124 of the attachment portion 112. The connector 114 allows connection of the cable tie assembly 108 with the loop 106 (see FIG. 1) of the connection point 104 (see FIG. 1). The connector 114 is movable with respect to the attachment portion 112. The connector 114 includes a locking portion 188 that can be engaged or disengaged. More particularly, the locking portion 188 may be disengaged for coupling the system 100 with the connection point 104. Further, the locking portion 188 may be engaged when the system 100 is attached with the connection point 104. The locking portion 188 is shown in the engaged position herein. In an example, the connector 114 is embodied as a carabiner. In alternate examples, the connector 114 may include any component that allows connection of the system 100 with the connection point 104. In the illustrated example, the connector 114 is manufactured as a separate component and is later assembled with the attachment portion 112 of the frame 110. In another example, the connector 114 is integral with the attachment portion 112 of the frame 110. More particularly, the connector 114 may be molded with the attachment portion 112 of the frame 110. In such an example, the connector 114 may be fixed with respect to the attachment portion 112.

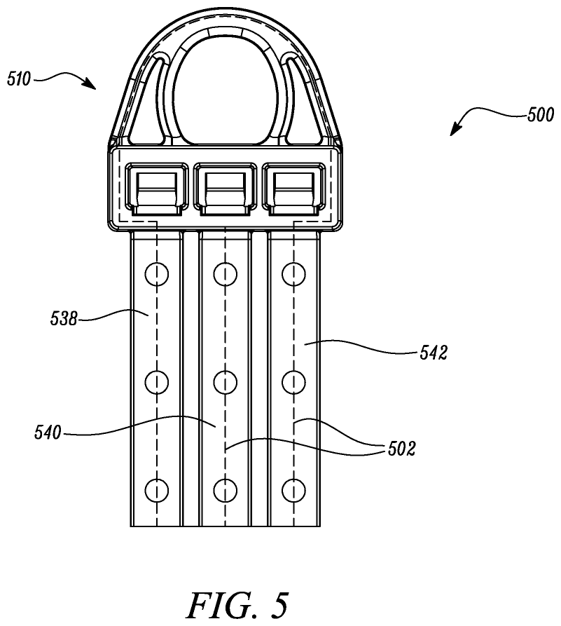

Referring now to FIG. 5, another embodiment of a cable tie assembly 500 is illustrated. The cable tie assembly 500 includes a frame 510 that is similar in design and construction to the frame 110 illustrated in FIGS. 2 to 4. Further, the cable tie assembly 500 includes a number of cable ties 538, 540, 542 that are similar design and construction to the cable ties 138, 140, 142 illustrated in FIGS. 2 to 4. The cable tie assembly 500 described herein includes an embedded member 502. More particularly, the frame 510 and two or more cable ties 538, 540, 542 are re-enforced with the embedded member 502 to add additional strength to the cable tie assembly 500. In the illustrated example, the embedded member 502 passes through the cable tie 538, the frame 510, and the cable tie 542. Further, the cable tie 540 is re-enforced with another embedded member 502. The embedded member 502 may embody a continuous fiber, cable, or wire to strengthen the cable tie assembly 500 that acts as an anchor point. The embedded member 502 may improve a durability of the cable tie assembly 500.

The system 100 described herein may be used to hold objects that do not include an integrated attachment point. The system 100 may be user friendly and may provide an improved means for securing and holding objects. Further, the system 100 may provide improved reliability and utility, and may be used on a wide range of product types.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A cable tie assembly comprising:
a frame comprising an attachment portion adapted to be coupled to a connector and a head portion defining a plurality of apertures therethrough, the head portion comprising a plurality of pawls, wherein each pawl is disposed within a corresponding aperture of the plurality of apertures; and
a plurality of cable ties attached to and extending from the head portion of the frame, the plurality of cable ties spaced apart from each other and bendable independently of each other, wherein each cable tie is adapted to be received through a corresponding aperture of the plurality of apertures, each cable tie comprising a plurality of teeth on a longitudinal surface thereof, each tooth of the plurality of teeth being engageable with a corresponding pawl of the plurality of pawls.

2. The cable tie assembly of claim 1, wherein the plurality of cable ties are adapted to be secured around an object having a varying cross-section.

3. The cable tie assembly of claim 1, wherein the cable tie assembly further includes a gripping member coupled with the plurality of cable ties.

4. The cable tie assembly of claim 3, wherein the gripping member receives a portion of each of the plurality of cable ties.

5. The cable tie assembly of claim 3, wherein the gripping member is adapted to be disposed around and contact an object that is secured to the cable tie assembly.

6. The cable tie assembly of claim 3, wherein the gripping member comprises a base portion, and a plurality of walls extending from the base portion and spaced apart from each other, wherein a plurality of channels is defined by the gripping member, each channel disposed between adjacent walls of the plurality of walls, wherein each channel at least partially receives a corresponding cable tie of the plurality of cable ties.

7. The cable tie assembly of claim 3, wherein each cable tie defines a plurality of holes therethrough, wherein the base portion further comprises a plurality of protrusions disposed within each channel, the plurality of protrusions received within the plurality of holes of the corresponding cable tie.

8. The cable tie assembly of claim 3, wherein the gripping member is made from a flexible material.

9. (canceled)

10. The cable tie assembly of claim 3, wherein the gripping member is integral with the frame.

11. The cable tie assembly of claim 1, wherein the cable tie assembly includes at least two cable ties.

12-13. (canceled)

14. The cable tie assembly of claim 1, wherein the attachment portion defines a connector opening therethrough, the connector opening adapted to be coupled to the connector.

15. The cable tie assembly of claim 14, wherein the attachment portion further comprises:
a curved section attached to the head portion and defining the connector opening;
a pair of lateral sections extending outwardly from the curved section and attached to the head portion.

16. A system for securing an object, the system comprising:
a cable tie assembly comprising:
a frame comprising an attachment portion and a head portion defining a plurality of apertures therethrough, the head portion comprising a plurality of pawls, wherein each pawl is disposed within a corresponding aperture of the plurality of apertures; and
a plurality of cable ties attached to and extending from the head portion of the frame, the plurality of cable ties spaced apart from each other and bendable independently of each other, wherein each cable tie is adapted to be received through a corresponding aperture of the plurality of apertures, each cable tie comprising a plurality of teeth on a longitudinal surface thereof, each tooth of the plurality of teeth being engageable with a corresponding pawl of the plurality of pawls, wherein the plurality of cable ties are secured around the object; and
a connector coupled to the attachment portion of the frame.

17. The system of claim 16, wherein the cable tie assembly further includes a gripping member coupled with the plurality of cable ties.

18. The system of claim 17, wherein the gripping member is adapted to be disposed around and contact the object.

19. The system of claim 17, wherein the gripping member is integral with the frame.

20. The system of claim 16, wherein the connector is integral with the attachment portion of the frame.

21. A cable tie assembly for holding an object, the cable tie assembly comprising:
a frame comprising an attachment portion adapted to be coupled to a connector and a head portion defining a plurality of apertures therethrough, the head portion comprising a plurality of pawls, wherein each pawl is disposed within a corresponding aperture of the plurality of apertures;
a plurality of cable ties attached to and extending from the head portion of the frame, the plurality of cable ties spaced apart from each other and bendable independently of each other, wherein each cable tie is adapted to be received through a corresponding aperture of the plurality of apertures, each cable tie comprising a plurality of teeth on a longitudinal surface thereof, each tooth of the plurality of teeth being engageable with a corresponding pawl of the plurality of pawls, wherein the plurality of cable ties are secured around the object; and
a gripping member coupled to the plurality of cable ties, the gripping member receiving a portion of each cable tie, wherein the gripping member is adapted to be disposed around and contact the object.

22. The cable tie assembly of claim 18, wherein the gripping member comprises a base portion, and a plurality of walls extending from the base portion and spaced apart from each other, wherein a plurality of channels is defined by the gripping member, each channel disposed between adjacent walls of the plurality of walls, wherein each channel at least partially receives a corresponding cable tie of the plurality of cable ties.

23. The cable tie assembly of claim 19, wherein each cable tie defines a plurality of holes therethrough, wherein the base portion further comprises a plurality of protrusions disposed within each channel, the plurality of protrusions received within the plurality of holes of the corresponding cable tie.
